(19) United States
(12) Patent Application Publication
(10) Pub. No.: US 2016/0103793 A1
(43) Pub. Date: Apr. 14, 2016

(54) Heterogeneous Application Tabs

(71) Applicant: Microsoft Technology Licensing, LLC, Redmond, WA (US)

(72) Inventors: Richard Fang, Bellevue, WA (US); Chaitanya Dev Sareen, Seattle, WA (US); Miron Vranjes, Seattle, WA (US); Robert J. Jarrett, Seattle, WA (US)

(21) Appl. No.: 14/514,024

(22) Filed: Oct. 14, 2014

(51) Int. Cl. G06F 17/21; G06F 3/0484; G06F 17/30

(52) U.S. Cl. CPC G06F 17/212; G06F 17/30905; G06F 17/30896; G06F 3/04845; G06F 3/04842

(57) ABSTRACT

This document describes techniques and apparatuses enabling heterogeneous application tabs. In some embodiments, these techniques and apparatuses enable grouping, sizing, and/or positioning of heterogeneous application tabs to provide an optimized layout of application content.

### BACKGROUND

This background is provided for the purpose of generally presenting a context for the instant disclosure. Unless otherwise indicated herein, material described in the background is neither expressly nor impliedly admitted to be prior art to the instant disclosure or the claims that follow.

Conventional applications, such as browsers, often permit users to view or interact with application content through different respective tabs. For example, a user browsing the Internet may open three different webpages by using three respective tabs of a browser. To view or interact with content of one of the tabs, the desired tab is typically selected as primary with respect to the other tabs. The content of the primary tab, however, often obscures the other tabs and limits the user's interaction to just that of the primary tab. Additionally, each application interface may only support tabs to present content of that particular application. For users that multi-task among different applications, this can lead to a proliferation of application interfaces that obscure one another. As such, interacting with content of multiple tabs or applications often requires a user to search or switch through multiple tabs or interfaces to find desired content, which can be time consuming, repetitive, and frustrating.

### SUMMARY

This document describes techniques and apparatuses enabling heterogeneous application tabs in an application window. The heterogeneous application tabs presented via the application window can be sized, positioned, or grouped to provide an optimized layout of different types of application content. In some embodiments, these techniques and apparatuses enable the content of two application windows to be presented in respective tabs of another application window. Also, in some embodiments the techniques and apparatuses enable a size or position of an application tab to be altered based on a selected predefined area of an application window. Further still, some embodiments enable joint dividers or joint corner controls, which enable multiple application tabs to be sized or positioned simultaneously. Further, some embodiments enable sizing or switching between application windows that have heterogeneous application tabs. In yet other embodiments, the techniques and apparatuses enable selection of an application tab for presentation in an application window.

This summary is provided to introduce simplified concepts that are further described below in the Detailed Description. This summary is not intended to identify essential features of the claimed subject matter, nor is it intended for use in determining the scope of the claimed subject matter. Techniques and/or apparatuses enabling heterogeneous application tabs are also referred to herein separately or in conjunction as the “techniques” as permitted by the context, though techniques may include or instead represent other aspects described herein.

### BRIEF DESCRIPTION OF THE DRAWINGS

Embodiments enabling heterogeneous application tabs are described with reference to the following drawings. The same numbers are used throughout the drawings to reference like features and components:

FIG. 1 illustrates an example system in which techniques enabling heterogeneous application tabs can be implemented.

FIG. 2 illustrates an example tablet computing device having a touch-sensitive display presenting multi-application environment.

FIG. 3 illustrates a method for presenting content of heterogeneous applications in respective tabs of an application window.

FIG. 4 illustrates an example application window having heterogeneous application tabs.

FIG. 5 illustrates a method for altering a size or position of an application tab based on a predefined area of an application window.

FIG. 6 illustrates an example predefined area of an application window.

FIG. 7 illustrates examples of heterogeneous application tabs being presented in predefined areas of an application window.

FIG. 8 illustrates additional examples sizing and positioning application tabs within an application window.

FIG. 9 illustrates a method for simultaneously sizing multiple application tabs using a joint divider.

FIG. 10 illustrates an example of sizing application tabs via a joint divider.

FIG. 11 illustrates additional examples of joint dividers and corner dividers that enable sizing of application tabs.

FIG. 12 illustrates an example method for managing an application window having heterogeneous application tabs.

FIG. 13 illustrates an example of switching to an application window having heterogeneous application tabs.

FIG. 14 illustrates an example method for enabling selection of an application tab for presentation in an application window.

FIG. 15 illustrates an example user interface for selecting an application tab to present in an application window.

FIG. 16 illustrates examples of adding an application window to a predefined area of an application window.

FIG. 17 illustrates an example device in which techniques enabling heterogeneous application tabs can be implemented.

### DETAILED DESCRIPTION

### Overview

This document describes techniques and apparatuses enabling heterogeneous application tabs in an application window. These apparatuses and techniques may enable application tabs of heterogeneous applications to be conveniently and efficiently positioned or sized to provide optimized layouts of application windows. In some embodiments, these techniques and apparatuses enable the content of two application windows to be presented in respective tabs of another application window. The techniques and apparatuses may also enable a size or position of an application tab to be altered based on a selected predefined area of an application window. Further still, the techniques and apparatuses may enable joint dividers or joint corner controls, which enable multiple application tabs to be sized or positioned simultaneously. Further, some embodiments enable sizing or switching between application windows that have heterogeneous application tabs. In yet other embodiments, the techniques and apparatuses enable selection of an application tab for presentation in an application window. These and other forms of application tab management may be enabled through predefined areas of the application window. These are but a few examples of many ways in which the techniques enable heterogeneous application tabs, others of which are described below.

Example System

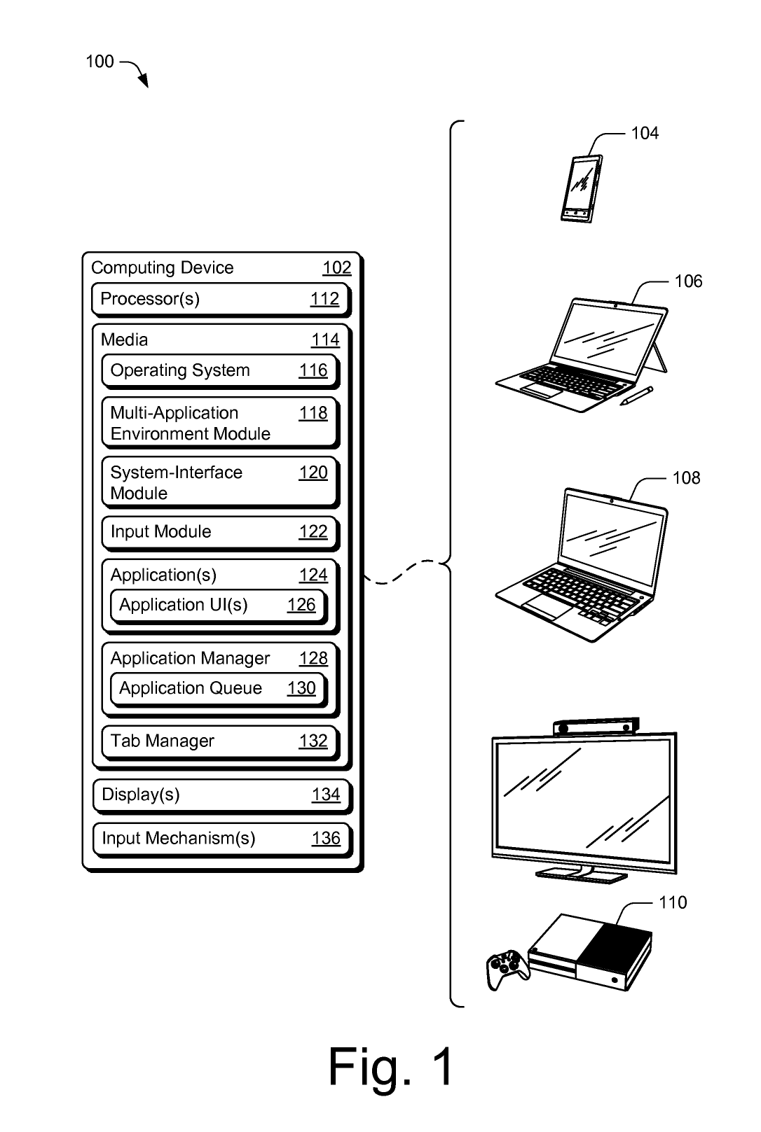

FIG. 1 illustrates an example system 100 in which techniques enabling heterogeneous application tabs can be embodied. System 100 includes a computing device 102, which is illustrated with four examples: a smart phone computer 104, a tablet computing device 106, a laptop computer 108, and a gaming device 110, though other computing devices and systems, such as set-top boxes, servers, and netbooks, may also be used.

Computing device 102 includes computer processor(s) 112 and computer-readable storage media 114 (media 114). Media 114 includes an operating system 116, multi-application environment module 118, system-interface module 120, input module 122, application(s) 124, each having one or more application user interfaces 126 (application UI(s) 126), application manager 128, which includes or has access to application queue 130, and application tab manager 132 (tab manager 132).

Computing device 102 also includes or has access to one or more displays 134 and input mechanisms 136. FIG. 1 illustrates four example displays, which may be separate or integrated with computing device 102. Input mechanisms 136 may include gesture-sensitive sensors and devices, such as touch-based sensors and movement-tracking sensors (e.g., camera-based), as well as mice (free-standing or integral with a keyboard), a stylus, touch pads, accelerometers, and microphones with accompanying voice recognition software, to name a few. Input mechanisms 136 may be separate or integral with displays 134; integral examples include gesture-sensitive displays with integrated touch-sensitive or motion-sensitive sensors.

Operating system 116 manages resources of computing device 102 and may be implemented using any suitable instruction format, such as 64-bit, 32-bit, reduced instruction set computing (RISC), complex instruction set computing (CISC), and the like. In some cases, operating system 116 may enable execution of a module or application having a different instruction format through virtualization. Operating system 116 enables other modules of computing device 102 to access the resources of computing device 102, such as multi-application environment module 118 and applications 124.

Multi-application environment module 118 provides a multi-application environment by which a user may view and interact with one or more of applications 124 through application UIs 126, which are presented via respective application windows or application tabs. In some cases, the multi-application environment is an overlapping windowing environment or workspace that enables management or manipulation of a position, size, and/or front-to-back ordering (collectively, “placement”) of overlapping windows (e.g., the z-ordering of the windows) or non-overlapping windows. The ordering or ‘depth’ of each application window in a workspace can be maintained via a z-stack of multi-application environment module 118. Typically, primary application or non-occluded application windows reside at the top of the z-stack. Other application windows, such as non-primary or occluded application windows reside at positions deeper in the z-stack. These non-primary application windows may overlap or occlude each other based on their respective positions within the z-stack.

In similar fashion, the multi-application environment may enable an overlapping tab environment within application windows that enables management or manipulation of a position, size, and/or primacy (collectively, “placement”) of overlapping tabs or non-overlapping windows. Typically, a primary application tab or non-occluded application tab is presented over at least a portion of a non-primary application tab, if any are present in the application window. These other application windows, such as the non-primary or occluded application tabs reside behind the primary application tab(s) and may be selected via a control portion that is not occluded by one of the primary application tabs.

Multi-application environment module 118 may present application UIs 126 (e.g., application tabs) through application windows having frames. These frames may provide controls through which to interact with an application and/or controls enabling a user to position and size the window. Alternately or additionally, multi-application environment module 118 may present application UIs 126 through application windows having little or no window frame, and/or without presenting visual controls (e.g., permanent controls on a window frame or in a window obscuring content).

The multi-application environment enabled by multi-application environment module 118 can be, but is not required to be, hosted and/or surfaced without use of a windows-based desktop environment. Thus, in some cases multi-application environment module 118 presents a multi-application environment as an immersive environment and precludes usage of desktop-like displays (e.g., a taskbar). Further still, in some embodiments this multi-application environment is similar to an operating system in that it is not closeable or capable of being un-installed. While not required, in some cases this multi-application environment enables use of all or nearly all of the pixels of a display by applications within the multi-application environment.

System-interface module 120 provides one or more interfaces through which interaction with operating system 116 is enabled, such as an application-launching interface, an application management user interface (application management UI), a start menu, a control panel, or a system tools or options menu, to name just a few. Input module 122 receives input through the application windows, input mechanisms 136, or other controls and affordances of a multi-application environment.

Applications 124 may include any suitable type of application, such as productivity applications, web browsers, media viewers, navigation applications, multimedia editing applications, and the like. Operating system 116 or multi-application environment module 118 may support applications of varying types or instruction sets natively or via virtualization. For example, multi-application environment module 118 may simultaneously present multiple applications 124 of varying types or instruction sets, such as 32-bit, 64-bit, run-time environments (e.g., Java or Silverlight, plug-ins (e.g., Flash), RISC, CISC, run-time-languages, and so on).

Each application 124 includes one or more application UIs 126, such as application windows or application tabs that enables viewing or interaction with content of the application. Application UIs 126 may include predefined properties or preferences (e.g., default values or settings) for presenting an application 124 via a tab or window, such as an aspect ratio, maximum size, minimum size, position, primacy, display orientation, and the like. In at least some embodiments, application programming interfaces (APIs) associated with an application 124 enable access to the properties or preferences of the application 124 or respective application UI 126.

Application manager 128 enables management of applications 124, such as launching, switching, and tracking active applications. In some cases, application manager 128 enables relationships between applications to be established and maintained, such as when a set of application tabs are added to an application window (e.g., grouping). Application manager 128 may also have access to, or maintain, application queue 130, which may include active applications, minimized applications, or previously-interacted-with applications. Applications of application queue 130 may be organized in any suitable fashion, such as most-recently-used, most-frequently-used, alphabetically, by application association, or by application grouping.

Tab manager 132 enables management of application tabs that are presented via the multi-application environment. In at least some embodiments, tab manager 132 enables techniques that position or size application tabs to provide an optimized layout of application content in an application window. Examples of these techniques and layouts of application tabs, some of which are presented based on predefined areas of an application window, are provided below, though they are not exhaustive or intended to limit the techniques described herein.

Any or all of operating system 116, multi-application environment module 118, system-interface module 120, input module 122, application(s) 124, application manager 128, and tab manager 132 may be implemented separate from each other or combined or integrated in any suitable form.

Example Methods

The methods described herein may be used separately or in combination with each other, in whole or in part. These methods are shown as sets of operations (or acts) performed, such as through one or more entities or modules, and are not necessarily limited to the order shown for performing the operation. For example, the techniques may present content of an application window in an application tab of another application window and automatically present the previously-presented content of the application window in an adjacent application tab. The techniques may also size and position an application tab based on a selected predefined area of an application window, present the sized application tab in the selected predefined area, and then establish a joint divider that enables the application tab and another application tab contacting the application tab to be simultaneously resized. These are but a few examples that may be implemented using the techniques described herein.

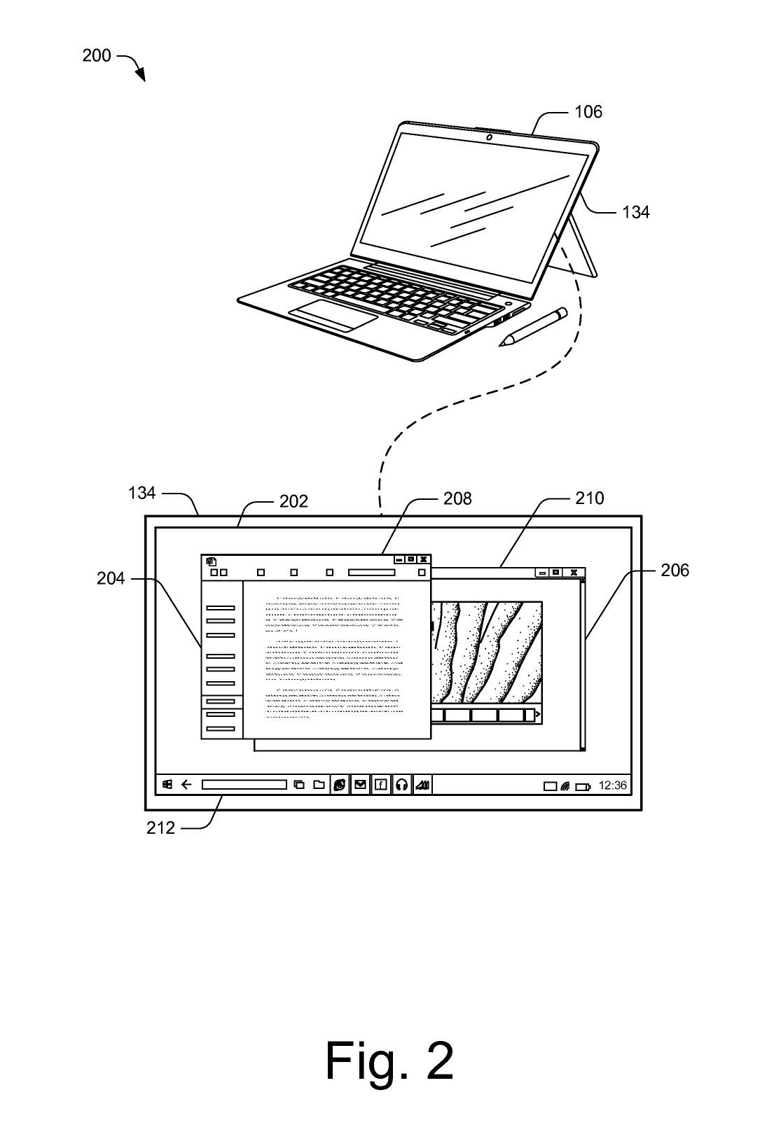

FIG. 2 illustrates an example operating environment 200 in which the techniques described herein can be performed. In this particular example, tablet computing device 106 presents, by use of multi-application environment module 118, multi-application environment 202 via display 134. Here, multi-application environment 202, which may also be referred to as a workspace, includes application window 204 and application window 206, each of which are presenting content of an associated application, respectively. In this particular example, application window 204 is presenting content of a browser application and application window 206 is presenting content of a word processing application.

As noted above, application windows may include controls that enable the application window to be sized, positioned, minimized, closed, and so on. In the context of the current example, application windows 204 and 206 include respective title bars 208 and 210, through which these controls are implemented. In some cases, a title bar of an application window may also include an application menu or application-specific controls, such as the word processing application controls shown generally along the top of title bars 208 and 210. Alternately, application windows may not include controls (not shown), which enables a user interface or content of an application to fully occupy a region or an area of multi-application environment 202. It should be noted that application windows without controls may still be sized, positioned, or otherwise manipulated by engaging an edge or contents of the application window.

Alternately or additionally, multi-application environment 202 may be implemented as a desktop, virtual or otherwise, and include a control area, which is shown as application management UI 212 or a start menu (not shown). For example, when implemented as a desktop, multi-application environment 202 may provide a windows-based workspace in which application windows can be individually moved, sized, or selected as a primary window (e.g. moved to the top of the z-stack).

Multi-application environment 202 may also provide one or more virtual desktops through which different sets of application windows can be presented or accessed. By way of example, a user may configure one virtual desktop with work-based or productivity application windows and another virtual desktop with media consumption application windows. By so doing, the user can interact with two different sets of application windows or application tabs by switching or pivoting between the two virtual desktops. In some cases, the user may switch an application window from another virtual desktop to a currently selected virtual desktop thereby precluding the need to pivot between the virtual desktops.

Application management UI 212 enables access to features and functions of operating system 116, system-interface module 120, or other applications 124 of computing device 102. For example, application tabs can be launched or switched from application management UI 212. Using the techniques herein, application tabs can be efficiently added, switched, positioned, sized, or otherwise manipulated in application windows to provide optimized layout application tabs and content thereof.

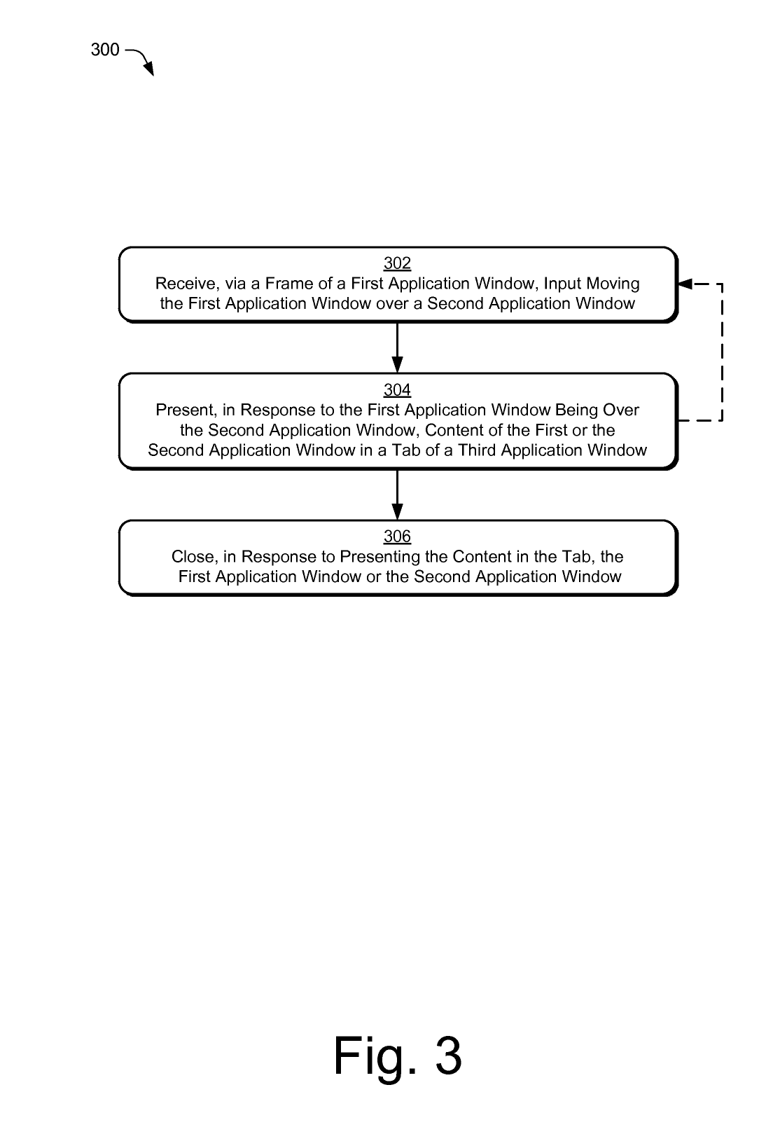

FIG. 3 depicts method 300 for presenting content of heterogeneous applications in respective tabs of an application window, including operations performed by tab manager 132 or multi-application environment module 118. In portions of the following discussion, reference may be made to system 100 of FIG. 1, the operating environment 200 of FIG. 2, and other methods and example embodiments described elsewhere herein, reference to which is made for example only.

At 302, input moving a first application window over a second application window is received. The input may be received via a frame or control portion of the first application window. The input includes any suitable type of input, such as touch input, mouse input, touchpad input, keyboard input, stylus input, and the like. The first and second application windows present content of respective applications, which may be of a same or different application type.

In some cases, a portion of the first application window is moved over or proximate a portion of the second application window. In such cases, the respective portions of the application windows may include title bars of the respective windows. Alternately or additionally, either of the application windows may include an application tab through which content of the application is presented.

By way of example, consider application windows 204 and 206 FIG. 2, which are presenting content of a word processing application and a browser application, respectively. Here, assume that a user wishes to place the content of the word application and the content of the browser application in a same application window for more-convenient access or viewing. To do so, the user drags, via touch input, title bar 208 of application window 204 over title bar 210 of application window 206.

At 304, content of the first application window or content of the second application windows is presented in a respective tab of a third application window. The content is presented via the respective tab of the third window in response to the first application window being moved over the second application window. In some cases, the third application window is provided by altering the first or second application window to provide the third application window. The third application window includes at least two respective application tabs through which the content of the first application window or second application window can be presented. Alternately or additionally, the third application window may be sized based on a maximum size of the first or the second application window. For example, the third application window can be sized to assume a size of the largest application window from which an application tab is received or created.

For example, a first application tab of content may be made primary and a second application tab of content may be made non-primary based on a default setting or a primacy of the application windows through which the content was presented. Alternately or additionally, both of the application tabs may be made primary thereby enabling the content of each application tab to be presented. In such cases, each application tab may be sized to occupy a predefined area of the third application window. Once presented or incorporated in the third application window, the third application window functions as a container for the application tabs. For example, sizing or movement applied to the third application window is signaled and applied to all the application tabs thereof.

From operation 304, method 300 may proceed to operation 306 or repeat operation 302 in order to add additional application tabs (e.g., 3, 4, 5, . . . N application tabs) to the third application window. For example, a third application tab of content can be added to the third application window in response to a fourth application window being moved over the third application window. At operation 306, the first application window or the second application window is closed. When one of the application windows is modified to provide the third application window, the other of the application windows is closed. Alternately, when the third application window is presented as a new window, both of the first and second application windows may be closed.

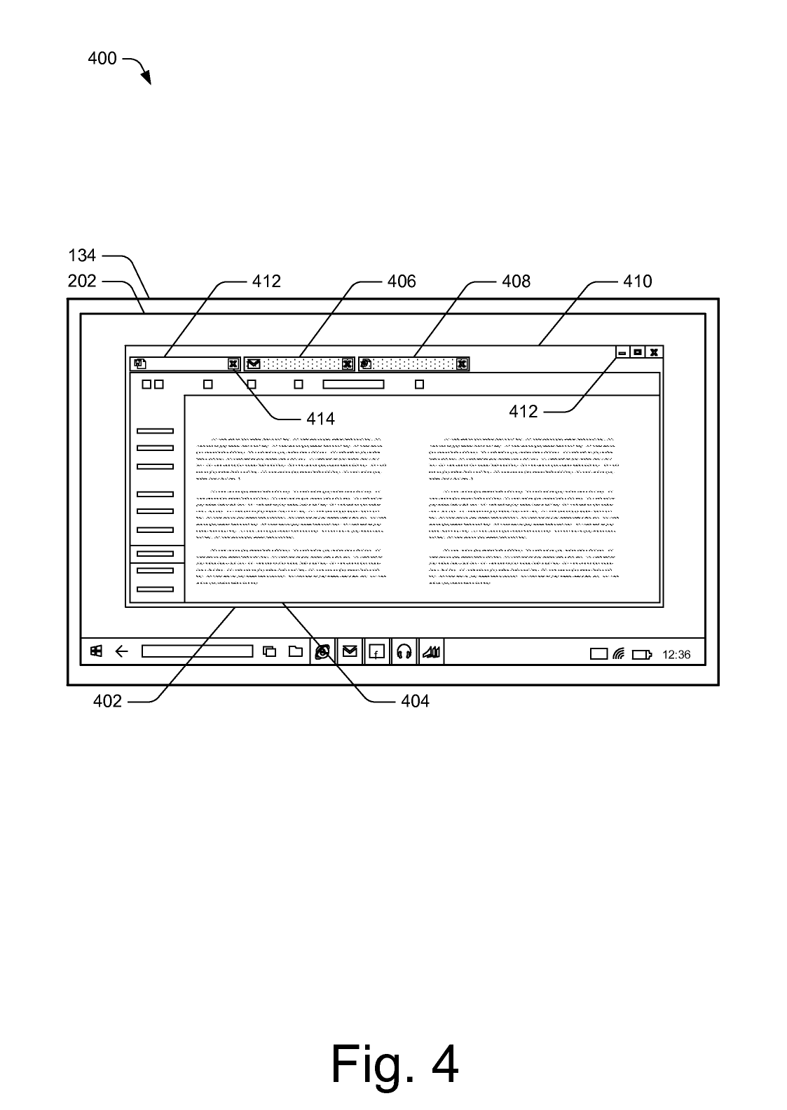

Concluding the above example, consider FIG. 4, which illustrates display 134 and multi-application environment 202 at 400 and in the context of method 300. Here, tab manager 132 modifies, such as by application tabs, application window 206 to provide application window 402, which includes application tabs 404, 406, and 408. The content of application window 204 is presented via application tab 404 and the content of application window 206 is accessible via application tab 408, as will be discussed in more detail below. Further, assume that by repeating operations 302 and 304, the user also added application tab 406 to application window 402, which includes content of an email application. In response to presenting the application tabs, tab manager 132 closes application window 204 and an application window previously-presenting the content of the email application.

Application window 402 also includes title bar 410 and tab control portion 412, which enable application window 402 and application tabs thereof to be minimized, maximized, or closed. Alternately or additionally, application window 402 may also be moved or sized (or resized) by input received through title bar 410 or other sections of a frame of application window 402. When application window 402 is sized, primary application tabs of application window 402 may also be resized to maintain their respective ratios with respect to an area of application window 402 occupied by each of the primary application tabs.

Each application tab includes a control portion, as shown by tab control portion 412 of application tab 404. Tab control portion 412 enables application tab 404 to be selected as a primary (e.g., foremost) application tab or closed via tab control 414. Typically, tab control portions for each application tab are visible, such as the control portions for application tabs 406 and 408. Here, note that application tabs 406 and 408 are not primary within application window 402 (as indicated visually by pseudo-shading of FIG. 4) and the content thereof is obscured by application tab 404, which is primary. The control portions of application tabs 406 and 408, however, are visible thereby enabling either application tab to be made primary within application window 402, closed, or, in some cases, moved to another application window.

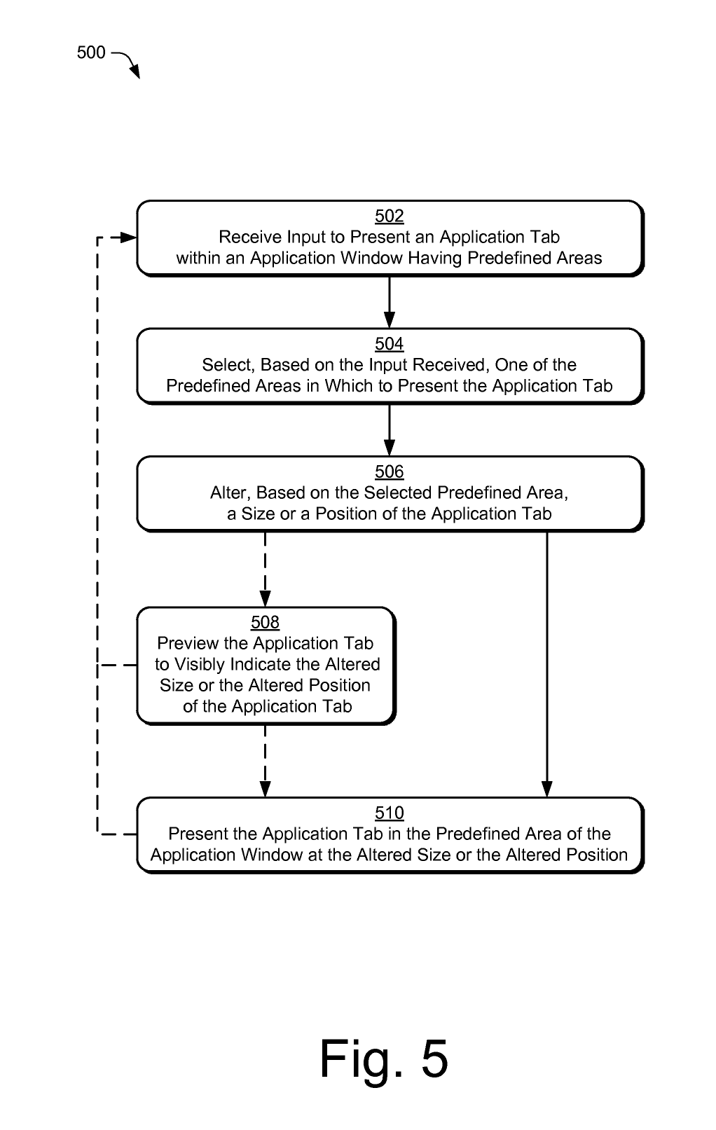

FIG. 5 depicts a method 500 for altering a size or position of an application tab based on a predefined area of an application window, including operations performed by tab manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 502, input is received to present an application tab within an application window having predefined areas. The input to present the application tab may include input to add the application tab to, make the application tab primary in, or move the application tab within the application window. The input may include any suitable type of input, such as directional input or gesture input received via a control portion of the application tab. In some cases, the input is received via a file protocol to launch a new application interface (e.g., window). In such cases, an application tab for the launched application may be auto-tabbed into an existing application window, such as the application window from which the application is launched. The predefined areas of the application window may include any suitable portion of the application window, such as a half area, third area, quarter area, quadrant, and the like.

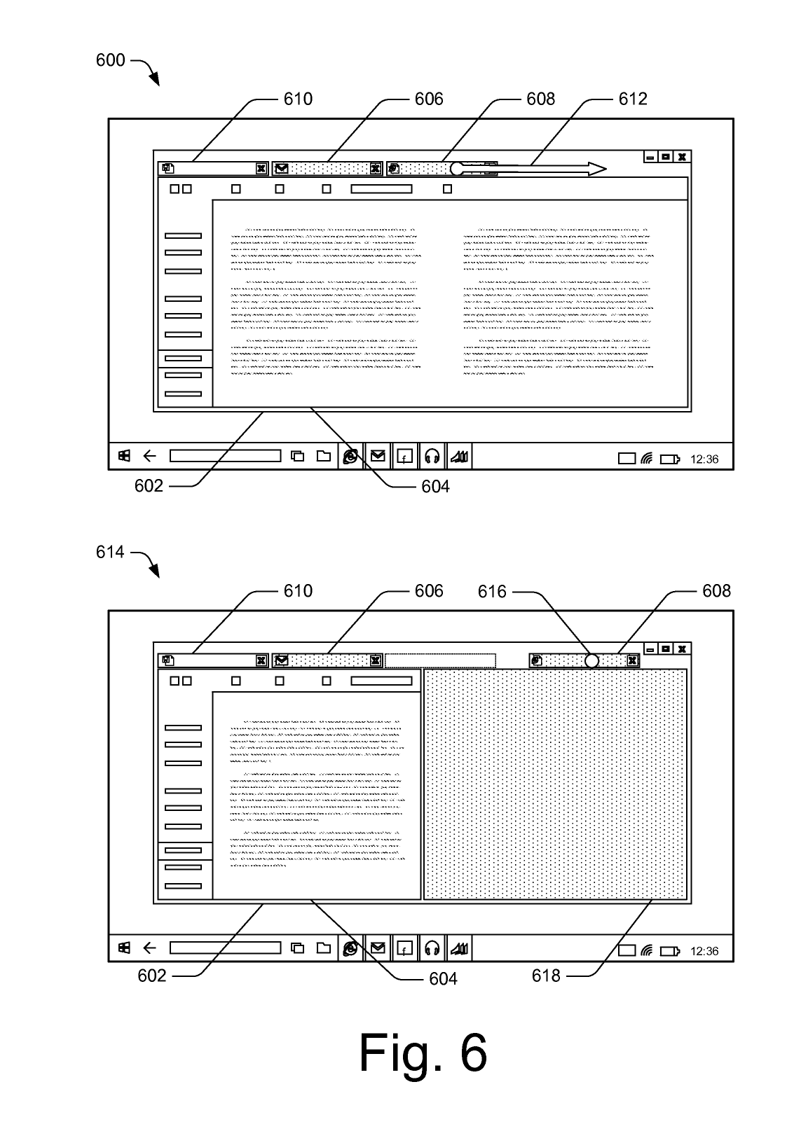

By way of example, consider workspace 600 of FIG. 6, which includes application window 602. Application window 602 includes application tabs 604, 606, and 608, of which application tab 604 is primary within application window 602. As shown in workspace 600, control portions of the non-primary application tabs 606 and 608 are visible along with control portion 610 of application tab 604. Here, assume that a user wishes to compare content of application tab 604 (word processing content) with content of application tab 608 (browser content). To do so, the user initiates drag input 612 via the control portion of application tab 608 towards a predefined area of application window 602.

At 504, one of the predefined areas of the application window is selected based on the input received. The predefined area may be selected based on a direction of the input received or a location at which the input concludes. For example, a dragging input received via a control portion of an application tab may conclude in a predefined area or a non-content portion of an application window associated therewith, such as a portion of a title bar. Alternately or additionally, an application window may include a non-content portion along the bottom of the application tabs. In some cases, this non-content portion may be presented in response to selection of a lower predefined area (e.g., bottom half or bottom quadrant) or include a control portion of application tabs that occupy the lower predefined areas.

In some embodiments, a configuration of a predefined areas may be determined based on a number of application tabs present in the application window or on which predefined areas are currently occupied by other application tabs. For example, if one application tab occupies the application window, predefined half areas of the application window may be available for selection. Additionally, if two or three application tabs occupy halves or thirds of the application window, respectively, thirds or quadrant areas may be available for selection. These are but a few examples of predefined areas of an application window, more of which are described below.

In the context of the present example, the content of a single application tab, application tab 604, occupies application window 602. Here, tab manager 132 determines that content of application tab 604 and application tab 608 can be presented through respective half areas of application window 602. As such and based on drag input 612, tab manager 132 selects a vertical half area of application window 602 in which to present content of application tab 608.

At 506, a size or position of the application tab is altered based on the selected predefined area. The size or position of the application tab is altered such that content of the application tab will substantially occupy the predefined area of the application window. Alternately or additionally, a primacy of the application tab is modified when a previously non-primary application tab is selected for presentation. In some cases, a size or position of a currently-presented application tab is also altered based on another predefined area, such as one that is complimentary to the selected predefined area. In such cases, the size or position of the currently-presented application window is altered such that the content of the currently-presented application tab substantially occupies the other predefined area.

In the ongoing example, tab manager 132 alters a size and position of application tab 608 such that the content of application tab 608 will fill the right half area of application window 602. Further, tab manager 132 alters a size of application tab 604 such that the content of application tab 604 will fill the left half of application window 602. To enable presentation of the content of application tab 608, tab manager 132 makes application tab primary within application window 602.

Optionally at 508, a preview of the application tab is presented to visually indicate the altered size or position of the application tab. The presentation of the preview may include showing other currently-presented application tabs at their respective altered sizes or positions, such as within other predefined areas of the application window. The preview of the application tab may be visually indicated by showing an outline of the predefined area in which the application tab, or content thereof, will be presented. Alternately or additionally, the preview of the application tab may be shaded or textured to increase visual contrast with other content of the application window. Receiving additional input or the cessation of input while the preview is presented may indicate selection of another predefined area or confirm selection of the currently-selected predefined area, respectively.

From operation 508, method 500 may proceed to operation 510 or return to operation 502 in response to additional input received while presenting the preview of the application tab. By returning to operation 502, the user is given the option to select another predefined area in which to present the application tab. Alternately, method 500 may proceed to operation 510 in response to the cessation of input, additional input confirming the selection of the predefined area (e.g., tap, mouse click, or keystroke), the expiration of an input timeout, and the like.

In the context of the current example, assume that the user concludes drag input 612 as shown in workspace 614 and holds his finger (or mouse cursor) at location 616. Here, tab manager presents preview 618 of application tab 608, which is visibly indicated by shading the right half of application window 602. Additionally, tab manager presents application tab 604 at its respective altered size, which fills the left half of application window 602.

At 510, the application tab is presented in the predefined area at the altered size or the altered position. The application tab may be presented such that the content of the application tab fills the predefined area of the application window. Additionally, other application tabs of the application window may be presented at their respective altered sizes or positions. By so doing, an optimized layout of application tabs can be presented within the application window. From operation 510, method 500 may be repeated, in whole or part, to enable a user to further optimize or customize the layout of application tabs of the application window.

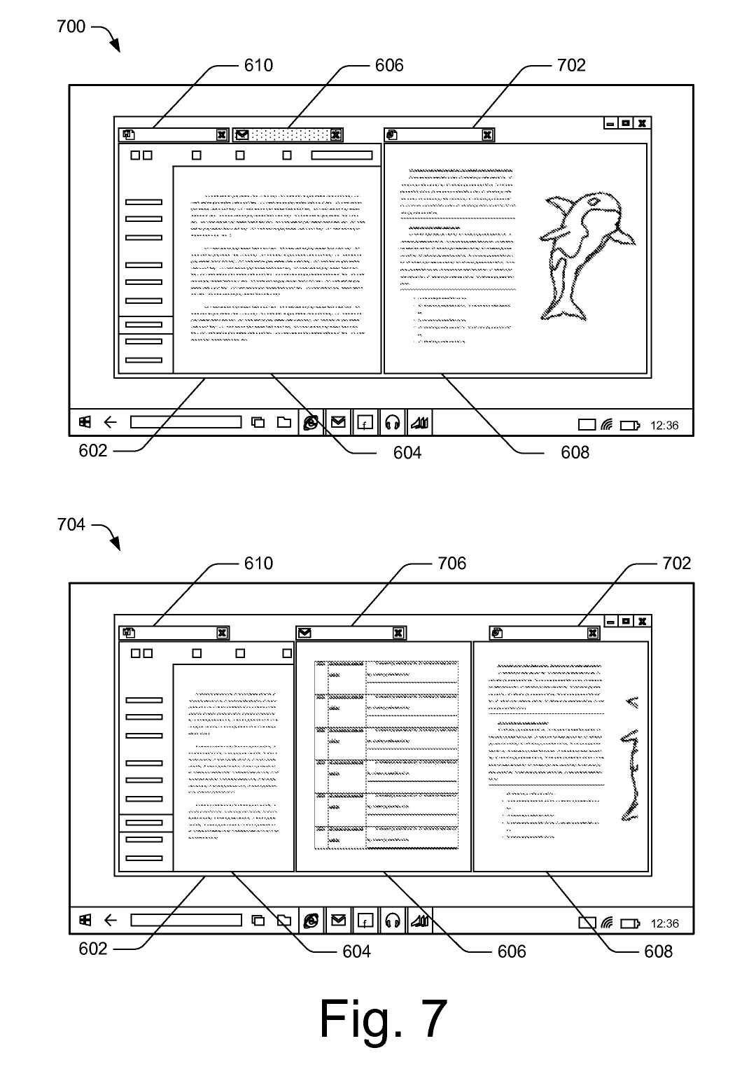

Concluding the present example, assume that the user ceases to provide input while preview 618 of application tab 608 is presented. As shown in workspace 700 of FIG. 7, tab manager 132 presents application tab 608 and the content thereof in the right half area of application window 602. Additionally, tab manager 132 presents control portion 702 above application tab 608, yet separate from the other control portions to indicate application tab 608's association with the half area of application window 602. To enable the presentation of application tab 608, tab manager presents application tab 604 in the left half area of application window 602.

By repeating operations of method 500, the user may also compare the content of application tab 606 with that of application tabs 604 and 608, or any suitable number of other application tabs. An example of this is shown in workspace 704, which illustrates the presentation of application tabs 604, 606, and 608 in respective third areas of application window 602. As noted above, control portion 706 is presented above application tab 606, yet separate from the control portions of the other application tabs to indicated association with the third area of application window 602. Alternately or additionally, application tabs may be removed from an application window by dragging the application tab, via a control portion, to another application window or a different area of a workspace.

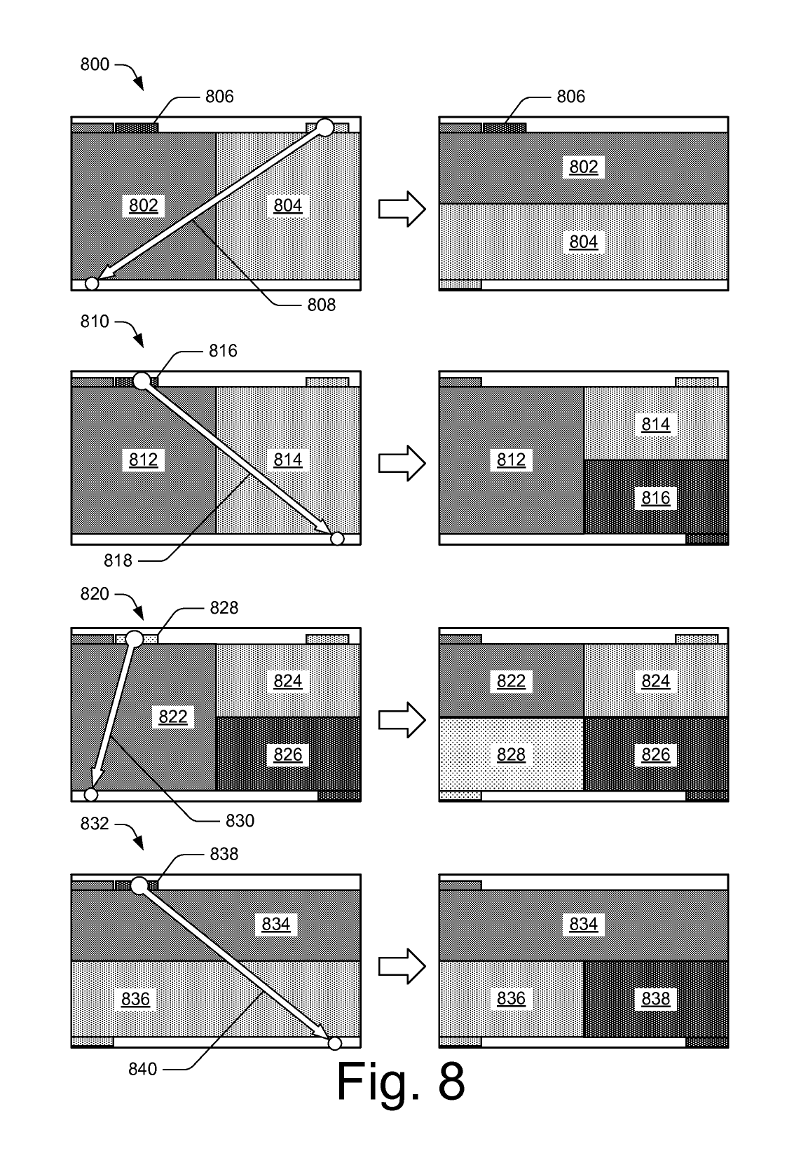

These are but a few examples of sizing and positioning an application tab for presentation within an application window to provide an optimized layout of content. Other examples of such are illustrated by FIG. 8, which includes application windows having various initial layouts of application tabs. Here, application window 800 includes application tabs 802 and 804, which occupy vertical half-areas of application window 800 and are primary with respect to application tab 806. In response to input 808, which drags a control portion of application tab 804 to the lower edge of application window 800, tab manager sizes and positions application tab 804 for presentation in the lower horizontal half-area of application window 800. To do so, tab manager 132 also sizes and positions application tab 802 for presentation in the upper horizontal half-area of application window 800.

Alternately, an application tab can be presented in a quarter-area or quadrant of an application window. This is illustrated by example application window 810, which includes application tabs 812, 814, and 816. Here, input 818 is received via a control portion of non-primary tab 816, which is dragged to the lower right corner of application window 810. In response to input 818, tab manager sizes and positions application tab 816 for presentation in the lower right quadrant of application window 810. To do so, tab manager 132 also sizes and positions application tab 814 for presentation in the upper right quadrant of application window 810.

As noted above, tab manager 132 may select a predefined area of an application window based on which predefined areas are occupied by other application tabs and a location at which the input is received. In some cases, tab manager 132 by be configured to resize or reposition other application tabs that are adjacent or proximate the received input. For example, dragging the control portion of application tab 816 to the center of application window 810's lower edge (not shown) may resize application tabs 812 and 814 to upper respective quadrants of application window 810. Tab manager 132 may then present application tab 816 in the lower horizontal half area of application window 810.

Next consider application window 820 that includes application tabs 822, 824, 826, and 828, the last of which is not primary. Here, input 830 drags a control portion of application tab 828 toward the lower left edge of application window 820. This is effective to cause tab manager 132 to resize application tab 822 to the upper left quadrant and present application tab 828 in the lower left quadrant of application window 820.

Horizontal half-areas of an application tab may also be split into quadrants for presenting application tabs. An example of this is shown by application window 832, which includes application tabs 834 and 836 that occupy respective horizontal half-areas of the application window. Here, a control portion of 838 is dragged, via input 840, to the opposite corner of application window 832. In response to this, tab manager resizes application tab 836 to permit the presentation of application tab 838 in the lower right quadrant of application window 832.

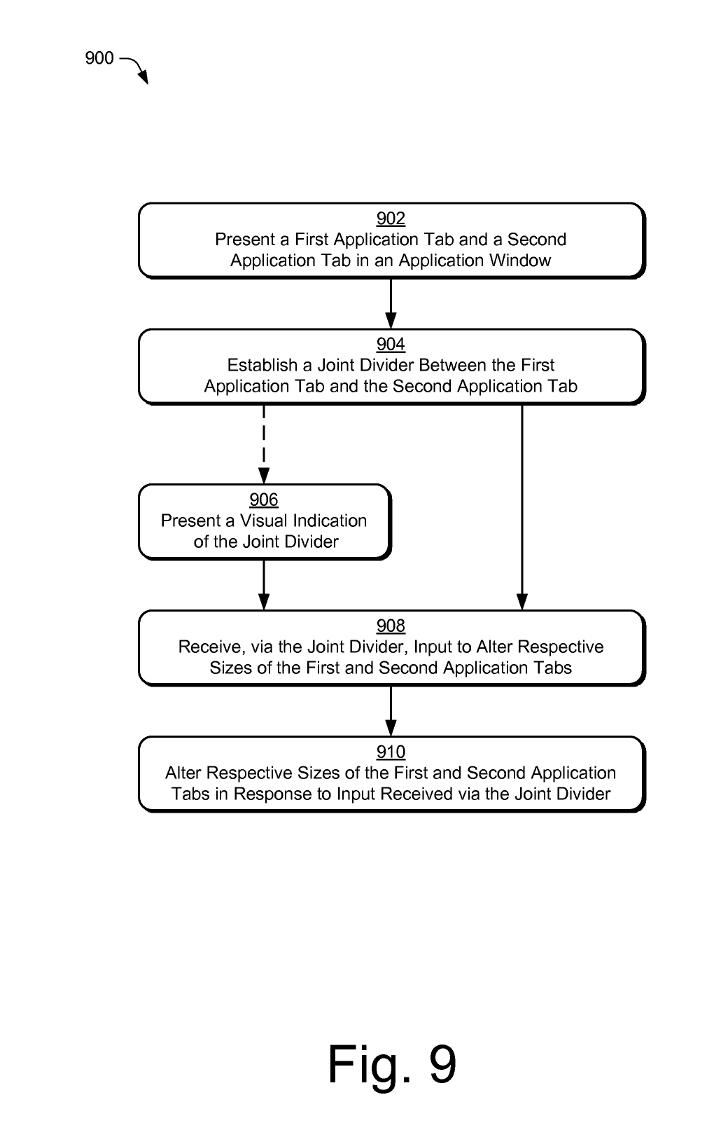

FIG. 9 depicts a method 900 for establishing a joint divider between application tabs of an application window, including operations performed by tab manager 132 or multi-application environment module 118. In portions of the following discussion reference may be made to system 100 of FIG. 1, operating environment 200 of FIG. 2, and other methods and example embodiments described elsewhere herein, reference to which is made for example only.

At 902, a first application tab and a second application tab are presented in an application window. The application tabs may be presented in respective predefined areas of the application window, such as a half, third, or quadrant of the application window. Each of the application tab includes content of a respective application, which may be different types of applications. In some cases, more than two application tabs are presented in, and occupy respective portions of, the application window.

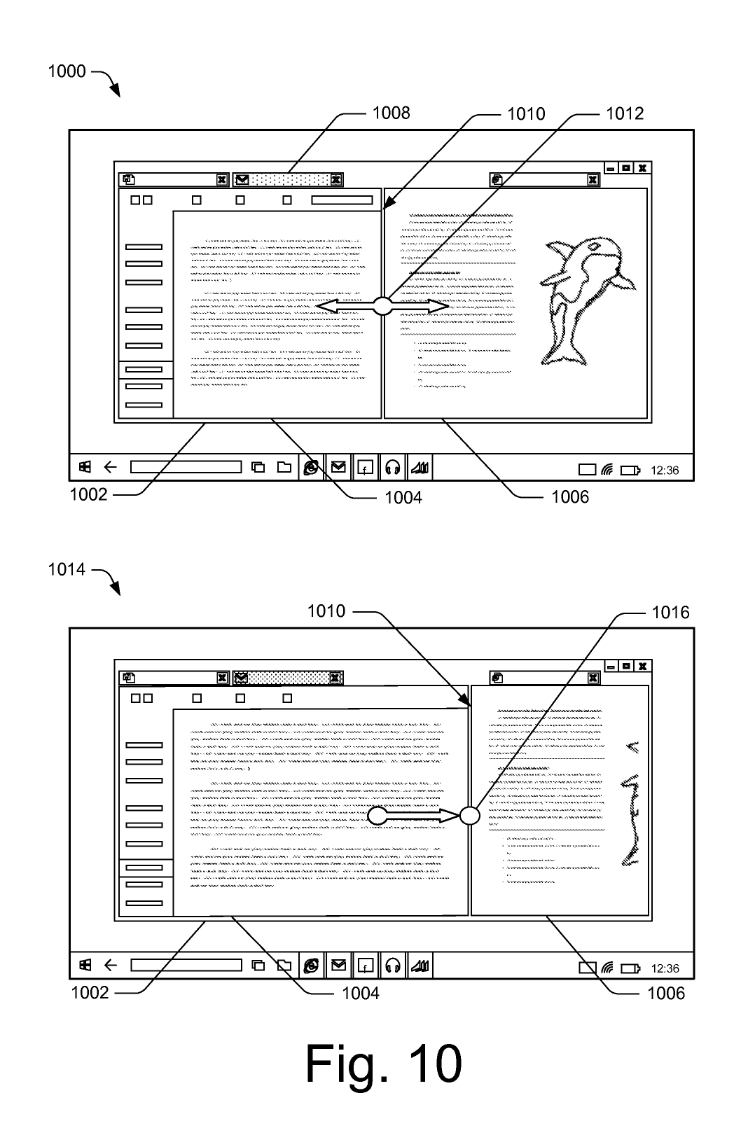

By way of example, consider workspace 1000 of FIG. 10, which includes application window 1002. Here, application tabs 1004 and 1006 are presented via respective half-areas of application window 1002. Application window 1002 also includes application tab 1008, which is non-primary and thus obscured mostly by application tabs 1004 and 1006.

At 904, a joint divider is established between the first application tab and the second application tab. The joint divider can be established wherever an edge of the first application tab contacts (e.g., touching with no overlap) an edge of the second application tab. In some cases, the joint divider is established along respective sections of each application tab that are in contact. In other cases, the joint divider is established along an entire length of each respective application tab, regardless of an amount of contact between the application tabs. Contact between the edges of the application tabs may be caused by any suitable operation, such as moving, adding, or sizing one of the application tabs in the application window. In the context of the present example, tab manager 132 establishes joint divider 1010 between, and along the adjacent edges of, application tabs 1004 and 1006.

Optionally at 906, a visual indication of the joint divider is presented. Presenting the joint divider may include providing a visual or haptic indication of the joint divider between the application tabs. The visual indication may be presented in response to input proximate the joint divider, such as when a cursor approaches the joint divider. In some cases, the visual indication is presented over or along the edges of application tabs that share the joint divider. In other cases, the visual indication is presented between two application windows that share the joint divider (e.g., joint gutter). In such cases, the size of one or both application windows may be reduced to provide space in which to present the joint divider. Alternately or additionally, haptic feedback (e.g., bumps or undulations) can be used to indicate a presence of the joint divider.

At 908, input to alter respective sizes of the first application tab and the second application tab is received via the joint divider. The input received may include any suitable type of input, such as directional input received via a cursor movement, touch input, or arrow keys. Continuing the ongoing example, input 1012 is received via joint divider 1010 to resize application tabs 1004 and 1006. Here assume that input 1012 is touch input received via a touchscreen, which enables a user to resize the application tabs by dragging joint divider 1010 in a horizontal direction.

At 910, the respective sizes of the first application tab and the second application tab are altered simultaneously in response to the input. The respective sizes of the application tabs may be altered as the input, such as directional cursor movement or touch input, is received. For example, the altered sizes of the application tabs may be visually indicated (e.g., previewed) by sliding the joint divider along an axis in which input is received. Thus, the sliding joint divider may visually indicate the simultaneous sizing of the first and second application tabs.

In some embodiments, one or more of the application tabs may be sized based on a user interface preference associated with the application tabs. For example, a size of the application tab may be reduced until a minimum size of the application tab is encountered by the joint divider. Once the minimum size of the application tab is encountered, tab manager 132 may cease to decrease the size of the application tab in accordance with the user interface preference.

Alternately or additionally, if subsequent input is received that would further decrease the size of a minimally sized application tab, a size of the application tab's application window could be increased to accommodate movement of the application tab in a direction of the input. In yet other cases, the minimally sized application window can be made non-primary, which would enable a further increase in size of an adjacent primary application tab via the joint divider. In such cases, the minimally sized window may be made primary again in response to the joint divider being dragged far enough to accommodate the application tab at its minimum size.

Movement of the joint divider may also exhibit an attraction or affinity (e.g., magnetism) for predetermined points along an edge of the application window. For example, the joint divider may ‘snap’ to points that are associated with predefined areas of the application window. By so doing, use of the joint divider may provide application tabs that are sized to predefined areas of the application window. This can be effective to aid a user in sizing application tabs in a symmetrical layout. Alternately, the attraction to points along edges of the application window can be disabled in response user preferences or key input (e.g., holding the CTRL key).

Concluding the present example, input 1012 drags joint divider 1010 to the right as shown in workspace 1014. Here, input 1012 ceases at point 1016 which is indicated by the position of joint divider 1010. Based on input 1012, tab manager increases the size of application tab 1004 and decreases the size of application tab 1006 such that the application tabs fill their respective portions of application window 1002.

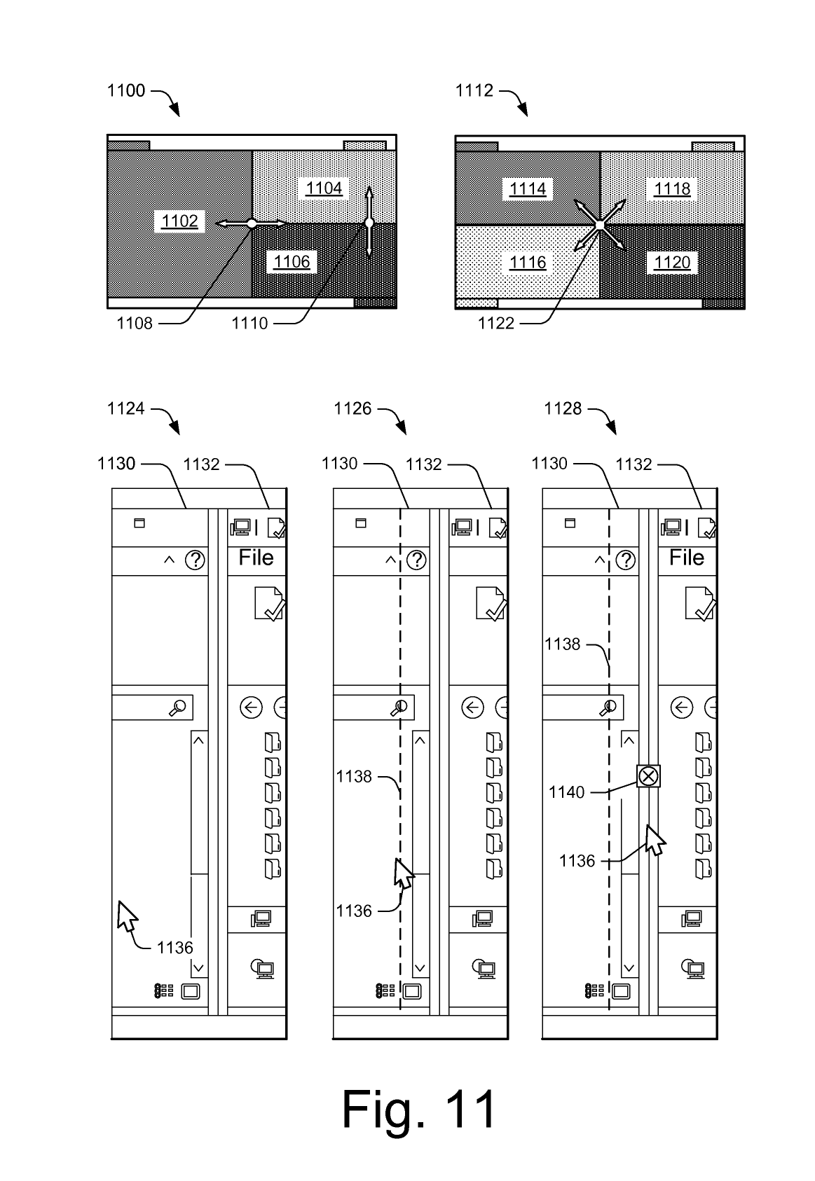

In some embodiments, joint dividers are established between multiple application tabs that contact each other along one or more edges. For example, a single joint divider can be established when respective edges of two application tabs contact an edge of a third application tab. By way of example, consider application window 1100 of FIG. 11, which includes application tabs 1102, 1104, and 1106. Here, joint divider 1108 is established where edges of application tabs 1104 and 1106 contact an edge of application tab 1102.

As shown in application window 1100, input received via joint divider 1108 enables sizing of all three application tabs along a horizontal axis. Additionally, joint divider 1110 is established where another edge of application tab 1104 contacts another edge of application tab 1106. As shown, input received via joint divider 1110 enables sizing of application tabs 1104 and 1106 along a vertical axis. Although shown as separate, joint divider 1108 and joint divider 1110 may be implemented together as a joint corner control at a point where edges of the application tabs meet. Input received via the joint corner may simultaneously size application tabs along a horizontal and/or vertical axis (e.g., diagonally).

An example of a joint corner is illustrated in application window 1112, which includes application tabs 1114, 1116, 1118, and 1120. Here, corner divider 1122 is established where two edges of each application tab contact respective edges of the other application tabs. Alternately or additionally, a corner control can be established wherever corners of two non-adjacent application tabs (e.g., application tabs 1114 and 1120) meet or are in contact. As shown, input received via joint corner 1122 enables all four of the application tabs to be simultaneously sized in both vertical and horizontal directions, such as though diagonal directional input.

In some embodiments, a joint-separation control or affordance is also presented such that a joint divider can be disabled. The joint-separation control can be presented over a section of the joint divider, an edge of the joint control, or both edges of the joint control. In some cases, the joint-separation control enables a user to ‘unbuckle’ the joint divider, which enables individual sizing or movement of application tabs previously sharing the joint divider.

The joint divider may also be disabled by other operations, such as double-clicking the joint divider, clicking the joint divider while holding a key (e.g., CTRL), or by sizing or moving an application window via an edge that is not part of the joint divider. In some embodiments, the joint-separation control may remove the joint control from the application window and reset a layout of the application tabs, such as by making a single one of the application tabs primary in the application window. In such cases, other application tabs previously associated with the joint control may be made non-primary or closed.

The joint-separation control can be presented in response to input or cursor movement is received proximate to the joint divider. FIG. 11 illustrates an example of presenting a joint-separation control in response to cursor movement. Movement of a curser is shown in a progression of illustrated workspaces, which includes application window 1124, application window 1126, and application window 1128. As shown in application window 1126, movement of cursor 1136 can be detected based on proximity threshold 1138. Proximity threshold 1138 may be configured having any suitable dimensions, such as 10 pixels from a joint divider, and may be reconfigured based on a type of input being received. As cursor 1136 crosses proximity threshold 1138, as shown in application window 1128, joint-separation control 1140 is presented over contacting edges of application tabs 1130 and 1132.

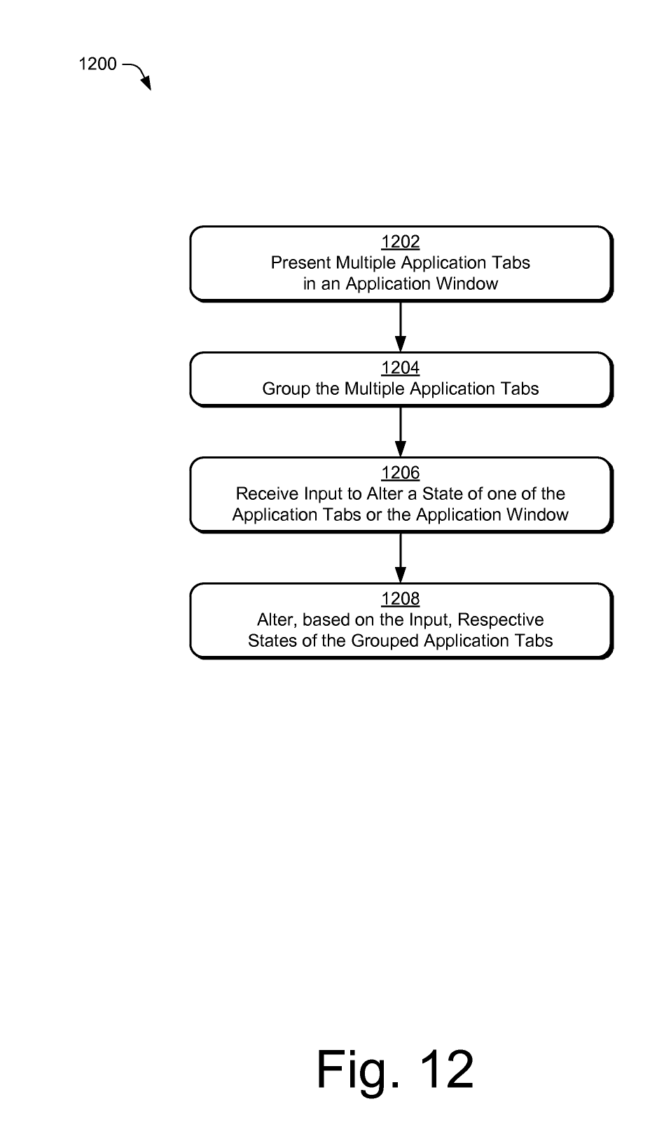

FIG. 12 depicts a method 1200 for grouping application tabs of an application window, including operations performed by tab manager 132 or application manager 128. In portions of the following discussion reference may be made to system 100 of FIG. 1, operating environment 200 of FIG. 2, and other methods and example embodiments described elsewhere herein, reference to which is made for example only.

At 1202, multiple application tabs are presented in an application window. The application tabs may be presented in respective predefined areas of the application window, such as a half, third, or quarter (e.g., quadrant) of the application window. In some cases, an application interface is of a fixed size, such as for a calculator application. In such cases, the application interface may be presented in the application tab at its native or fixed size. Each of the application tab includes content of a respective application, which may be different types of applications. Alternately or additionally, some of the application windows may be non-primary such that only a control portion of the application tab is presented at a top or bottom non-content area of the application window.

By way of example, consider workspace 1300 of FIG. 12, which includes application windows 1302 and 1304. Although not shown, assume that application tabs of window 1302 are configured similar to those of application window 602 of FIG. 7 and include application tabs 604, 606, and 608. Additionally, application tabs 1306, 1308, and 1310 are presented in application window 1304. Here, application tabs 1306 and 1308 are primary tabs within application window 1304 and present content of a spreadsheet application and a calculator application, respectively. Note that a size and aspect ratio for the content of the calculator application is fixed and thus presented by native application interface 1312 within application tab 1308.

At 1204, the multiple application tabs of the application window are grouped together. A respective set of application tabs can be grouped for each application window in a multi-application environment, which may provide multiple groups of application tabs. In some cases, groups of application tabs are also associated with a respective virtual desktop. In such cases, a user may pivot between different virtual desktops to access different groups of application tabs.

Grouping the application tabs is effective to enable operations to be performed on the grouped application windows. For example, grouped application tabs may be opened, closed, minimized, resized, switched to/from, or moved together. For example, when one application tab is switched to, a parent application window and application tabs grouped with the application tab may be made primary in the multi-application environment. In some cases, the grouped application tabs are presented together in switching affordances, such as a start menu, application management UI, or hotkey switcher (e.g., ALT+Tab or Windows™+Tab).

In the context of the present example, application manager 128 groups application tabs 604, 606, and 608 of application window 1302 together. Recall that in the context of FIG. 6, that these application tabs were accessed and organized by the user to write a research paper. Application manager 128 also groups application tabs 1306, 1308, and 1310 are presented in application window 1304. Here, assume that the user has accessed and arranged these application tabs to complete an accounting assignment. As such, the user has created two groups of application tabs, one group for writing the research paper and another group to complete an accounting assignment.

At 1206, input to alter a state of one of the application tabs or the application window is received. This input may include input to minimize, maximize, switch to, or close the application window. In some cases, the input is received through the title bar of the application window through which the application tabs are presented or through a title bar of a non-primary application window. In other cases, the input may be received by using an application management menu or queue. For example, one or a group of application tabs may be selected for presentation through a switching affordance, such as a start menu, application management UI, hotkey switcher, and the like. In the ongoing example, assume that the user wishes to switch projects and work on his research paper. To do so, the user selects one of the application tabs of application window 1302 by cycling through an application queue using ALT+Tab or Windows™+Tab.

At 1208, respective states of the grouped application tabs are altered based on the input received. This may include minimizing, maximizing, switching to, restoring, or closing the group of application tabs. When switching to or restoring the group of application tabs, the application tabs may be presented based on a previous state, such as a configuration or layout of the application tabs had prior to being minimized, closed, or made non-primary. Concluding the present example, application manager makes application window 1304, the application tabs thereof, primary in workspace 1314. Thus, through selection of a single application tab, the user is able to access another group of application tabs relevant to his project.

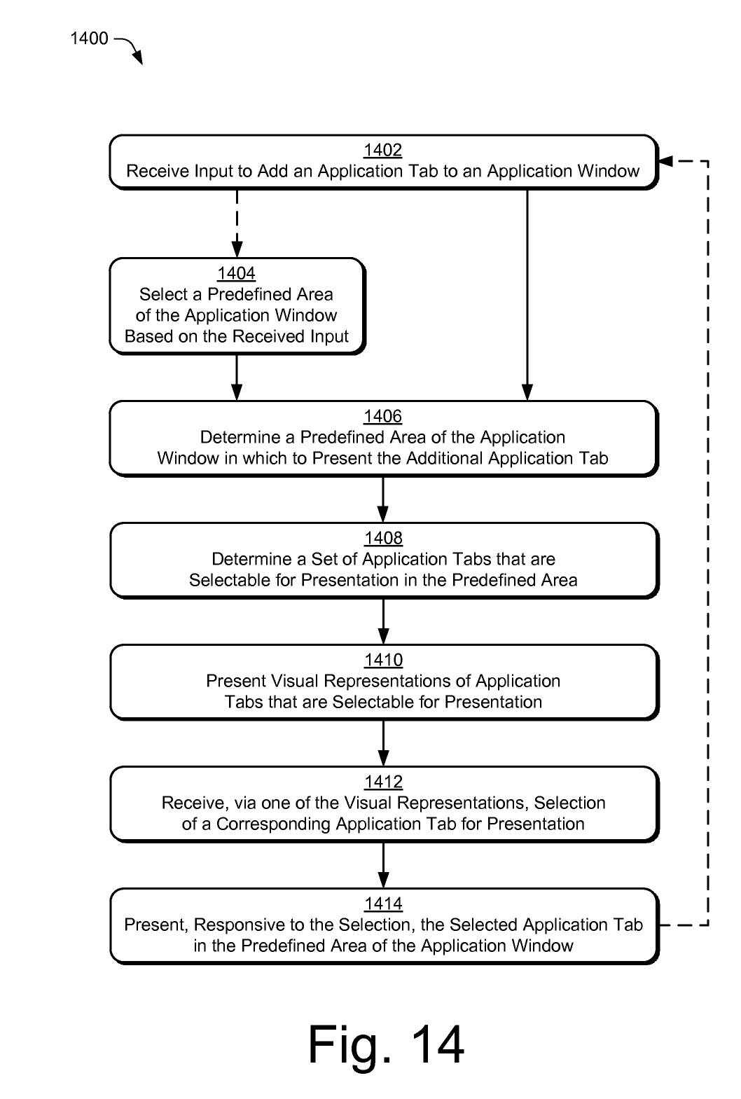

FIG. 14 depicts a method 1400 for adding an application tab to an application window, including operations performed by tab manager 132 or multi-application environment module 118. In portions of the following discussion, reference may be made to system 100 of FIG. 1, operating environment 200 of FIG. 2, and other methods and example embodiments described elsewhere herein, reference to which is made for example only.

At 1402, input to add an application tab to an application window is received. The application window may include any number of existing application tabs that occupy respective areas, predefined or otherwise, of the application window. In some cases, the input is gesture input, tap input, or directional input received by a control portion of an application tab or an application tab control associated with the application window. In such cases, the application tab control can be located proximate control portions of other application tabs or in a title bar of the application window. Alternately or additionally, other types of input may be received, such as voice input, keyboard input (e.g., function keys or hotkeys), and the like.

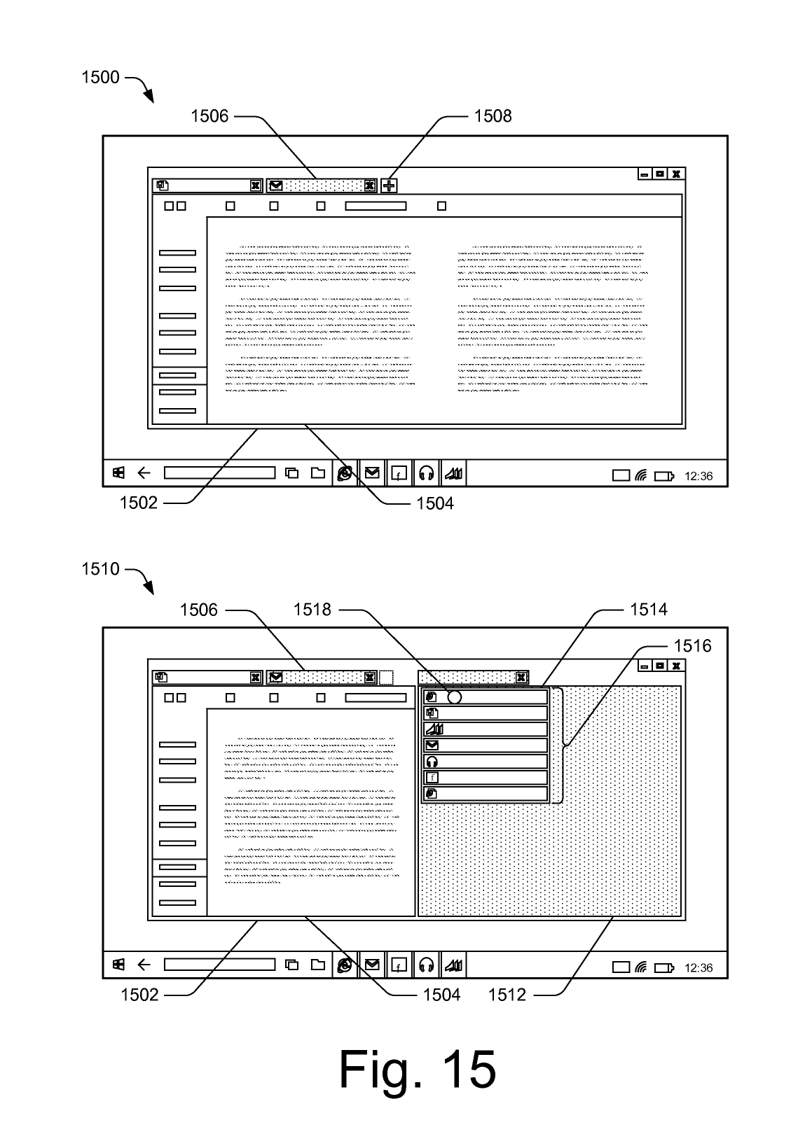

By way of example, consider workspace 1500 of FIG. 15, which includes application window 1502. Application window 1502 includes application tabs 1504 and 1506, of which application tab 1504 is primary within application window 1502. As shown in workspace 1500, a control portion of the non-primary application tab 1506 is visible in the title bar area of application window 1502. Additionally, application window 1502 includes an application tab control 1508 (e.g., tab launcher) located adjacent to the control portions of application tabs 1504 and 1506. Here, assume that a user, currently working with content of application tab 604 (word processing content), desires to add another application tab within application window 1502 in which to present content of a web browser. To do so, the user initiates a tap input via application tab control 1508 of application window 1502.

Optionally at 1404, a predefined area of the application window in which to add the application tab is selected. The predefined area of the application window is selected based on the input received at operation 1402 (e.g., drag input) or additional input received thereafter (e.g., subsequent tap input). The predefined area of the application window may be selected based on a direction of the input received or a location at which the input concludes. For example, a dragging input received via the application tab control may conclude in a predefined area or a non-content portion of an application window associated therewith, such as a portion of a title bar. Alternately or additionally, an application window may include a non-content portion along the bottom of the application tabs. In some cases, this non-content portion may be presented in response to selection of a lower predefined area (e.g., bottom half or bottom quadrant) or include a control portion of application tabs that occupy the lower predefined areas.

At 1406, a predefined area in which to present the additional application tab is determined. This determination may be based on the input received at operation 1404, such as when a user provides input indicative of a desired area in which to present the application tab. Alternately, the predefined area may be selected based on areas of the application window that are occupied by currently-presented application tabs. In some cases, existing application tabs of the application window are re-sized to account for the area to be occupied by the additional application tab. For example, if two existing application tabs occupy respective half-areas of the application window, these application tabs may be re-sized to third-areas thereby enabling another third-area to be selected for presentation of the additional application tab.

In the context of the present example, tab manager 132 determines a predefined area of application window 1502 in which to add another application tab. Because the user did not indicate a desired area in which to add the application tab, tab manager 132 determines, based on primary application tab 1504, a predefined area in which to add the other application tab. This is illustrated in workspace 1510 of FIG. 15, in which half-area 1512 is selected for presentation of the additional application tab. Here, note that application tab 1504 is re-sized to preview a size of the application tab being added to the application window.

At 1408, a set of application tabs that are selectable for presentation in the predefined area is determined. These application tabs may be associated with any suitable document, task, application, content, message, notification, and the like. In some cases, the set of application tabs includes application tabs that are grouped or linked with existing application tabs of the application window. For example, any application tab that was previously presented with an application tab currently presented in the application window may be selectable to add back to the application window. In other cases, the selectable application tabs may be most-recently-used, most-frequently-used, or user-defined default application tabs.

Continuing the ongoing example, tab manager 132 compiles a set of application tabs for selection by the user. This set of application tabs includes most-recently-used application tabs, most-frequently-used application tabs, and application tabs that are grouped with application tab 1504 or the content thereof. The grouped application tabs may include application tabs that were previously presented in an application window with the word processing application of application tab 1504.

At 1410, visual representations of application tabs are presented in the predefined area of the application window. These application tabs include those application tabs that are selectable for presentation in the predefined area. The visual representations of the application windows may include text, icons, or reduced-sized images of the application tabs or associated applications, such as thumbnail images. These reduced-sized images may visibly indicate a preview of an application windows content or previously-presented content. In some cases, the visual representations are presented via a menu or list proximate the predefined area. In such cases, the visual representations of the application tabs may be ordered or organized based on any suitable criteria, such as most-recent-use, most-frequent-use, relevancy to existing application tabs, and the like.

In the context of the present example, application tab launch menu 1514 (tab launcher 1514) is presented in half-area 1512 of application window 1502. Here, tab launcher 1514 includes application icon set 1516, which represent respective application tabs that are selectable for presentation in half-area 1512. These application tabs include the most-recently-used application tabs, most-frequently-used application tabs, and application tabs that are grouped with application tab 1504.

At 1412, input selecting one of the application tabs is received via a corresponding one of the visual representations. The input may include any suitable input, such as cursor input, gesture input, or touch input. In some cases, the input includes gesture or directional input effective to select another predefined area in which to present the application tab (e.g., dragging the visual representation to another desired area). Continuing the ongoing example, tap input 1518 is received via the visual representation of the browser icon of tab launcher 1514.

At 1414, the selected application tab is presented in the predefined area of the application window. The application tab is sized to fill or completely occupy the predefined area of the window. In some cases, however, the user interface of the application may not occupy the entire application tab (e.g., calculator or fixed-size applications). Prior to presenting the application tab, a preview of the application tab may be presented to visibly indicate the size or position of the application tab within the application window.

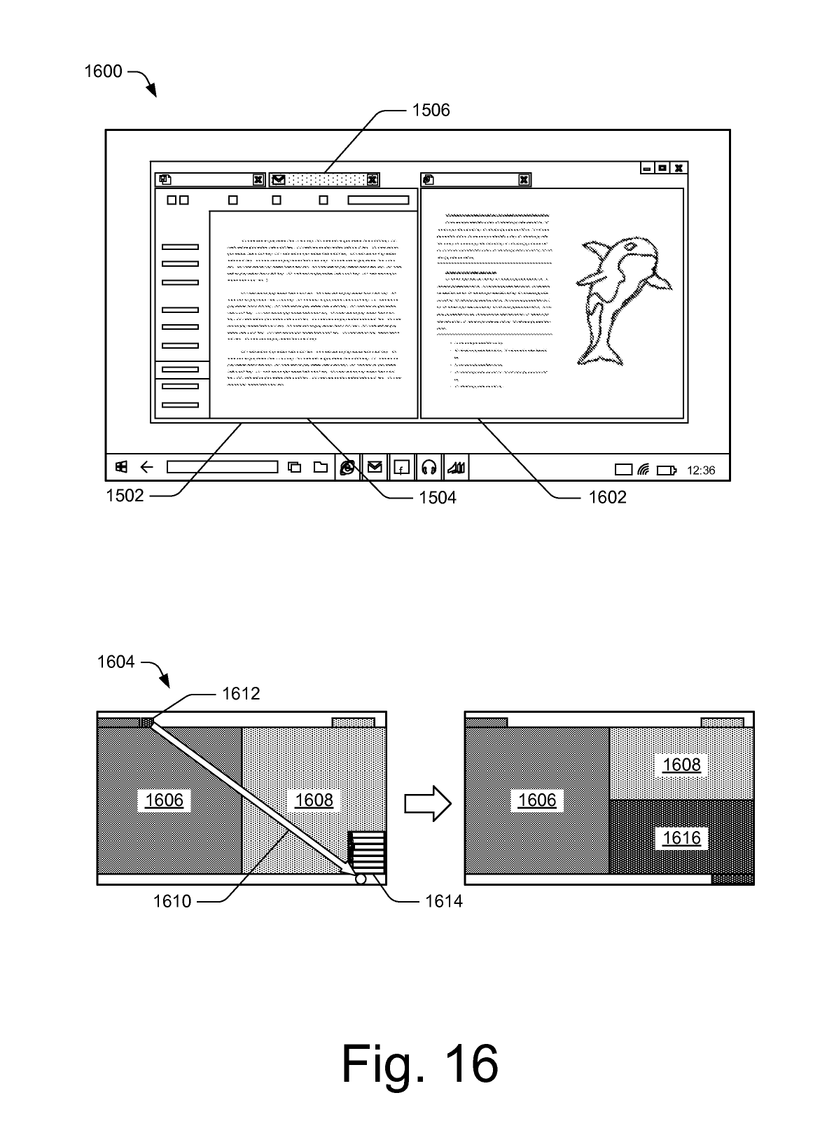

Concluding the present example, workspace 1600 of FIG. 16 illustrates the presentation of application tab 1602 in the half-area of application window 1502. This enables the user to conveniently view both the word processing and browser content in respective application tabs of a single application window.

Optionally, operations of method 1400 may be performed repeatedly to divide and fill other predefined areas of the application window. By so doing, an optimized layout of application windows can be provided with minimal user interaction. This is illustrated by example application window 1604, which includes application tabs 1606 and 1608. Here, input 1610 is received via application tab control 1612, which is dragged to the lower right corner of application window 1604. In response to input 1610, tab manager 132 presents tab launcher 1614, which enable the user to select an additional application tab for presentation in application window 1604. Tab manager 132 then presents, in response to selection of an application tab, application tab 1616 in the lower-right quadrant of application window 1604. Alternately or additionally, application tabs may be added to other predefined areas of an application window via directional input, such as the input and/or area combinations illustrated in FIG. 8. These are but a few examples of how application tabs can be added to an application window, more of which may be implemented using any combination of the techniques described herein.

Aspects of these methods may be implemented in hardware (e.g., fixed logic circuitry), firmware, a System-on-Chip (SoC), software, manual processing, or any combination thereof. A software implementation represents program code that performs specified tasks when executed by a computer processor, such as software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computing devices.

Example Device

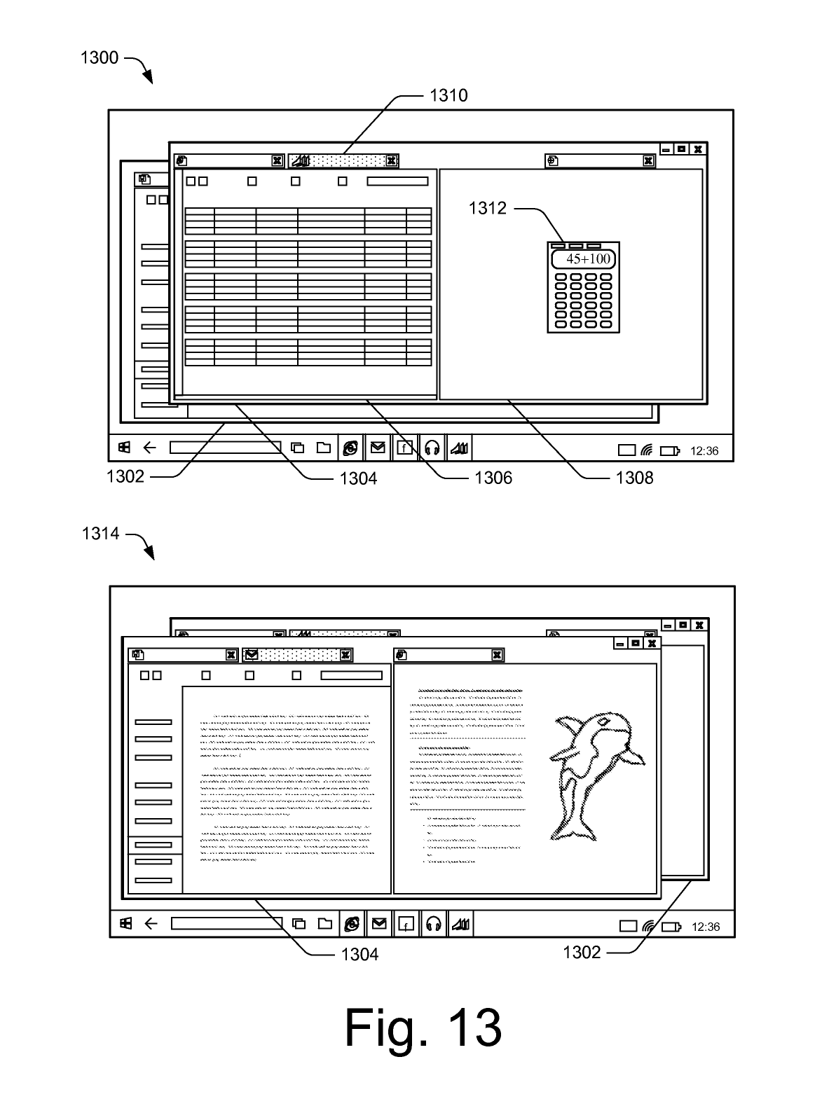

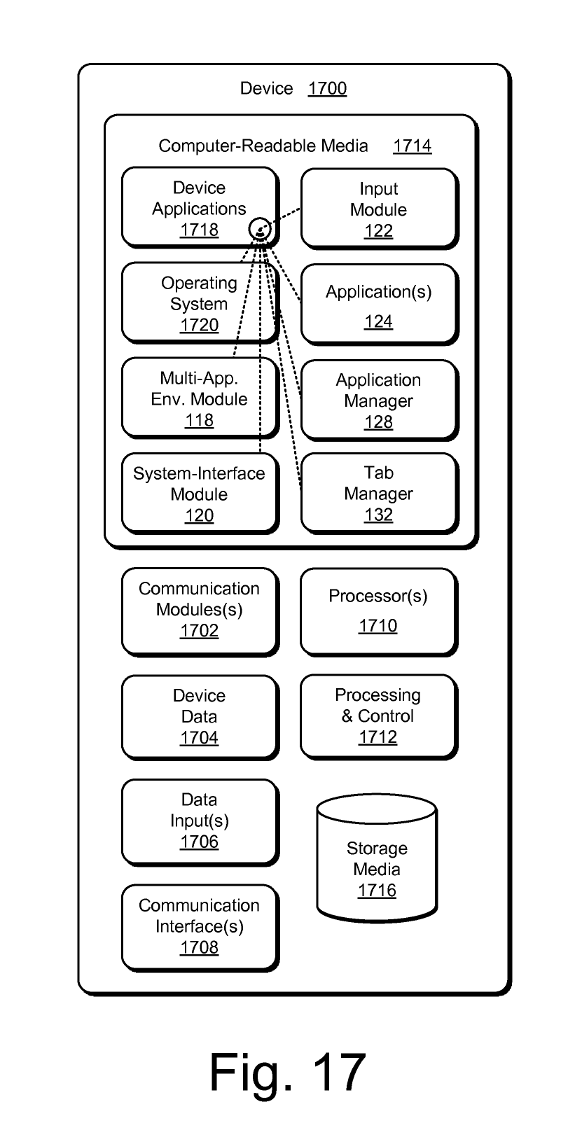

FIG. 17 illustrates various components of example device 1700 that can be implemented as any type of client, server, and/or computing device as described with reference to the previous FIGS. 1-16 to implement techniques enabling heterogeneous application tabs. In embodiments, device 1700 can be implemented as one or a combination of a wired and/or wireless device, as a form of television client device (e.g., television set-top box, digital video recorder (DVR), etc.), consumer device, computer device, server device, portable computer device, user device, communication device, video processing and/or rendering device, appliance device, gaming device, electronic device, and/or as another type of device. Device 1700 may also be associated with a user (e.g., a person) and/or an entity that operates the device such that a device describes logical devices that include users, software, firmware, and/or a combination of devices.

Device 1700 includes communication modules 1702 that enable wired and/or wireless communication of device data 1704 (e.g., received data, data that is being received, data scheduled for broadcast, data packets of the data, etc.). Device data 1704 or other device content can include configuration settings of the device, media content stored on the device, and/or information associated with a user of the device. Media content stored on device 1700 can include any type of audio, video, and/or image data. Device 1700 includes one or more data inputs 1706 via which any type of data, media content, and/or inputs can be received, such as user-selectable inputs, messages, music, television media content, recorded video content, and any other type of audio, video, and/or image data received from any content and/or data source.

Device 1700 also includes communication interfaces 1708, which can be implemented as any one or more of a serial and/or parallel interface, a wireless interface, any type of network interface, a modem, and as any other type of communication interface. Communication interfaces 1708 provide a connection and/or communication links between device 1700 and a communication network by which other electronic, computing, and communication devices communicate data with device 1700.

Device 1700 includes one or more processors 1710 (e.g., any of microprocessors, controllers, and the like), which process various computer-executable instructions to control the operation of device 1700 and to enable techniques enabling a multi-application environment. Alternatively or in addition, device 1700 can be implemented with any one or combination of hardware, firmware, or fixed logic circuitry that is implemented in connection with processing and control circuits which are generally identified at 1712. Although not shown, device 1700 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1700 also includes computer-readable storage media 1714, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1700 can also include a mass storage media device 1716.

Computer-readable storage media 1714 provides data storage mechanisms to store device data 1704, as well as various device applications 1718 and any other types of information and/or data related to operational aspects of device 1700. For example, an operating system 1720 can be maintained as a computer application with the computer-readable storage media 1714 and executed on processors 1710. Device applications 1718 may include a device manager, such as any form of a control application, software application, signal-processing and control module, code that is native to a particular device, a hardware abstraction layer for a particular device, and so on.

Device applications 1718 also include any system components or modules to implement the techniques, such as multi-application environment module 118, system-interface module 120, input module 122, application(s) 124, application manager 128, and tab manager 132.

### CONCLUSION

Although embodiments of techniques and apparatuses enabling heterogeneous application tabs have been described in language specific to features and/or methods, it is to be understood that the subject of the appended claims is not necessarily limited to the specific features or methods described. Rather, the specific features and methods are disclosed as example implementations enabling heterogeneous application tabs.

What is claimed is:

1. A computer-implemented method comprising:
receiving, via a frame of a first application window, input moving the first application window over a second application window in a multi-application environment, the first and second application windows presenting first and second content, respectively; and
presenting, in response to at least a portion of the first application window being over at least a portion of the second application window, the first content in a first tab of a third application window or the second content in a second tab of the third application window that includes the first and second application tabs.

2. The computer-implemented method as described in claim 1, further comprising closing the first application window or the second application window.

3. The computer-implemented method as described in claim 1, wherein the first application window is an application interface for a first application, the second application window is an application for a second application, and the first and second applications are different types of applications.

4. The computer-implemented method as described in claim 1, further comprising presenting the first content in the first tab of the third application window and the second content in the second tab of the third application window.

5. The computer-implemented method as described in claim 1, further comprising sizing the third application window to a size of the first or the second application window, and wherein a size of the first tab of the third application window is approximately equal to a size of the second tab of the third application window.

6. The computer-implemented method as described in claim 1, wherein at least one of the first or second application windows does not include a tab through which content is presented.

7. The computer-implemented method as described in claim 1, wherein the at least a portion of the first application window includes a title bar of the first window and the at least a portion of the second application window includes a title bar of the second application window.

8. A system comprising:
one or more processors;
one or more computer-readable media storing processor-executable instructions that, responsive to execution by the one or more processors, perform operations comprising:
receiving input to present an application tab within an application window having predefined areas in which to present application tabs, the application window including another application, the application tab and the other application tab associated with different types of applications, respectively;
selecting, based on the input received, one of the predefined areas in which to present the application tab;
altering, based on the selected predefined area, a size or a position of the application tab such that the application tab fills the predefined area; and
presenting the application tab in the selected predefined area of the application window at the altered size or the altered position.

9. The system as described in claim 8, wherein the presentation of the application tab is responsive to a request to add the application tab to the application window, make the application tab a primary application tab of the application window, or move the application tab from another predefined area of the application window.

10. The system as described in claim 8, wherein the operations further comprise presenting, prior to presenting the application tab in the selected predefined area, a preview of the application tab to visibly indicate the altered size or the altered position of the application tab within the application window.

11. The system as described in claim 9, wherein the other application tab occupies at least a portion of the selected predefined area and the operations further comprise:
determining, for the other application tab, another size or another position for the other application tab such that the application tab fills another predefined area of the application window; and
presenting the other application tab at the other determined size or the other determined position in the other predefined area effective to permit the application tab to be presented in the selected predefined area.

12. The system as described in claim 9, wherein the predefined areas of the application window include one of:
a first predefined area that occupies approximately one half of the application window;
a second predefined area that occupies approximately one third of the application window; or
a third predefined area that occupies approximately one quarter of the application window.

13. The system as described in claim 9, wherein the input is initiated via a control portion of the application tab and concludes within the selected predefined area of the application window.

14. The system as described in claim 9, wherein the input includes touch input, mouse input, touchpad input, keyboard input, voice input, or stylus input.

15. One or more computer-readable media storing processor-executable instructions that, responsive to execution by one or more processors, cause the one or more processors to perform operations comprising:
presenting a first application tab and a second application tab in an application window, the first application tab and the second application tab each being associated with a different type of application;
establishing, responsive to a first edge of the first application tab contacting a second edge of the second application tab, a joint divider between the first and second application tabs; and
altering respective sizes of the first application tab and the second application tab simultaneously in response to input received via the joint divider.

16. The one or more computer-readable media as described in claim 15, wherein the operations further comprise further comprising presenting:
a visual indication of the joint divider established between the first window tab and the second window tab; or
a joint divider control configured to close the first application tab or the second application tab effective to eliminate the joint divider.

17. The one or more computer-readable media as described in claim 15, wherein the operations further comprise:
presenting a third application tab in the application window;
extending, responsive to a third edge of the third application tab contacting the second edge of the second application tab, the joint divider between the third and second application tabs; and
altering respective sizes of the first application tab, the second application tab, and the third application tab simultaneously in response to input received via the joint divider.

18. The one or more computer-readable media as described in claim 15, wherein altering the respective sizes of the first and second application tabs comprises increasing the size of the first application tab, decreasing the size of the second application tab, and the operations further comprise ceasing, based on a minimum tab size for the second application tab, to alter of the respective sizes of the first and the second application tabs.

19. The one or more computer-readable media as described in claim 18, wherein the operations further comprise:
receiving, via the joint divider and while the second application tab is presented at the minimum size, additional input to further increase the size of the first application tab; and
ceasing to present the second application tab effective to enable the size of the first application tab to be increased further; or
increasing a size of the application window in a same direction of the additional input effective to enable the size of the first application tab to be increased further.

20. The one or more computer-readable media as described in claim 15, wherein the operations further comprise snapping, in response to the input received via the joint divider, the joint divider to an edge of a predefined area of the application window effective to size the first application tab or the second application tab to the predefined area.
